(19) United States
(12) Patent Application Publication
(10) Pub. No.: US 2004/0098283 A1
(43) Pub. Date: May 20, 2004

(54) Method of promoting conservation easements in real property

(76) Inventor: Mark Shea, Provo, UT (US)

Correspondence Address: Vaughn W. North, THORPE NORTH & WESTERN, LLP, P.O. Box 1219, Sandy, UT, 84091-1219, US

(21) Appl. No.: 10/633,403

(22) Filed: Jul. 31, 2003

Related U.S. Application Data
(60) Provisional application No. 60/400,219, filed on Jul. 31, 2002.

(51) Int. Cl. G06F 17/60

(52) U.S. Cl. 705/1

(57) ABSTRACT

A method of encouraging the formation of conservation easements on real property is disclosed. The method comprises identifying a parcel of real property owned by a first party and suitable for securing a conservation easement wherein the first party is unable to utilize a maximum monetary value generated by the conservation easement; selling an interest in the identified parcel of real property to an intermediate party qualified to receive maximum tax deduction benefit for the conservation easement; processing the conservation easement on the parcel of real property with proper government authorities; and exchanging at least a portion of the monetary value in the real property with the conservation easement to the intermediate party for consideration less than the maximum monetary value.

Priority of application Ser. No. 60/400,219 filed Jul. 31, 2002, in the United States Patent Office is hereby claimed.

### BACKGROUND OF THE INVENTION

The present invention relates generally promoting the development of conservation areas through the granting of conservation easements on real property.

The conservation movement has been very successful in educating the public about the need to husband resources and protect lands from development for future enjoyment by the next generation such that the land is still in its natural or historic state. In some cases, wealthy philanthropists donate the land for a public good and the government manages the land through a trust typically set up by the philanthropist.

Some lands, however, are able to be utilized by the property owner, yet, the desire to restrict the future development of that property is also important so rather than grant the land over to the government or a non-profit entity in its entirety, federal and state governments have established what are called conservation easements that allow the landowner to retain ownership of the land, but provide the public with assurances that the land will not be developed against the restrictions of the easement.

A conservation easement is a set of restrictions a landowner voluntarily places on his or her property in order to preserve its conservation values. The conservation values of the property and the restrictions created to preserve those values, along with the rights reserved by the landowner, are detailed in a legal document known as a conservation easement. This document is filed with the local county land records. Conservation easements are utilized to allow interested landowners the opportunity to preserve important natural and scenic resources by limiting the use and development of their land.

A conservation easement is conveyed to a government agency or non-profit conservation organization qualified to hold and enforce easements. Most conservation easements are perpetual. They apply to the current owner and all future landowners, permanently protecting the property. Furthermore, each conservation easement is unique, specifically tailored to the particular land being protected as well as to the particular situation of the landowner.

Conservation easements are typically utilized to protect lands that serve as natural habitat for wildlife, fish and plants and include areas such as prairies, forests, bluff lands, or wetlands. They protect lands that have lakeshore, rivers and streams that are desired to be preserved. Further, they serve to protect scenic landscapes, particularly those with local community, cultural or historic significance.

When a conservation easement is crafted, the conservation values are first defined and then restrictions are created to protect those values. Restrictions may apply to all of a landowner's property or to only a portion of it. Typically, easements address subdivision, commercial or industrial uses, mining, construction of buildings or roads, utilities, disturbance of the vegetation or topography. These easements preclude activities on the property that might interfere with the conservation purpose for the easement. For example, an easement preserving rare woodland habitat may require that the property be left entirely in its natural state, prohibiting all development. Or, to protect a lake or stream, an easement may allow limited inland construction of buildings or trails while restricting such activities along the more fragile shoreline. Some easements may permit continued farming or limited timbering. Others may provide for enhancement of wildlife habitat or restoration of native prairie. Still others may provide for recreational activity such as hunting or fishing, or sports activities such as golf, hiking or cycling.

After a conservation easement has been placed on the landowner's property, the landowner still retains all rights to the property not specifically restricted or relinquished by the easement. The landowner still owns the land and has the right to use it for any purpose that is consistent with the easement, to sell, to transfer or to leave it through a will. Typically, landowners also retain the right to restrict public access.

Since the landowner continues to possess the land, the landowner remains responsible for the land such as for its maintenance and upkeep, for paying taxes and for otherwise meeting the typical obligations of landownership. Conservation easements add only a few further requirements. These typically include notifying the state land trust of any proposed changes to the property, allow for periodic monitoring visits of the property, notifying the state land trust when selling or transferring the property is to occur, and to comply with the restrictions in the easement.

Conservation easements are encouraged because they are a cost-effective tool to protect a state's increasingly threatened land and water resources, preserve wildlife habitat, safeguard the waters and capture scenic vistas for present and future enjoyment. Conservation easements provide landowners with a living legacy as they have protected the land so that it will be respected and remain essentially the same throughout time.

In order to encourage greater use, conservation easements have been structured to provide financial benefits for their creation. These benefits are intended to promote and reward those who relinquish their rights and encumber their lands with such easements. Firstly, a conservation easement can result in a tax deduction both on the federal income tax as well as the state tax, depending upon the conservation easement statutes in that particular state. The donation of the conservation easement may allow the owner to claim such a federal income tax deduction for the value of the easement.

The value of the easement is calculated under several possible methods. In one method, the easement is valued as the difference in value of the land as appraised before and after the easement has been placed on the land. Another method of valuing the easement is to appraise the land for its possible economic development value, less the cost necessary to provide such development, and then less the cost of the land with the easement placed thereon.

If the easement is granted via a will, the conservation easement may reduce the federal estate tax, which makes this an effective way to transfer land to the next generation with its natural features intact. Further, as the easement reduces the value of the land, it may also result in lowered annual property taxes.

Often, the value of the tax deduction for the easement exceeds the ability of the landowner to fully take advantage of the value of the tax benefit. At times, the inability of the landowner to make full use of the tax benefit tends to discourage the landowner from placing an easement on the land as the economics of doing such makes it difficult for the landowner to dedicate the land to the public through the restrictions established in the easement. Such limitations deter expansion of the conservation easement program and therefore frustrate the public policy of land preservation.

Accordingly, what is needed is a method of enhancing the incentive to the landowner to grant a conservation easement on the landowner's property as well as to maximize the monetary interests that the easement can generate so as to promote the granting of more easements than would otherwise be possible.

### SUMMARY OF THE INVENTION

According to the present invention, a method of encouraging the formation of conservation easements on real property is disclosed. The method comprises identifying a parcel of real property owned by a first party and suitable for securing a conservation easement wherein the first party is unable to utilize a maximum monetary value generated by the conservation easement; selling an interest in the identified parcel of real property to an intermediate party qualified to receive maximum tax deduction benefit for the conservation easement; processing the conservation easement on the parcel of real property with proper government authorities; and exchanging at least a portion of the monetary value in the real property with the conservation easement to the intermediate party for consideration less than the maximum monetary value.

### BRIEF DESCRIPTION OF THE DRAWINGS

FIG. 1 is a block diagram of the formation of a conservation easement with an attending investment group(s) that encourages such easements in accordance with an embodiment of the present invention.

FIG. 2 is a flow diagram of the encouragement of conservation easements involving the group(s) of FIG. 1.

FIG. 3 depicts a flow diagram of determining the monetary value of the easement.

FIG. 4 depicts a flow diagram of determining the monetary value of the easement based on a virtual business plan in accordance with the present invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

Conservation easements serve as an important tool for increasing the stock of lands that are protected from future development for the preservation of either their natural beauty or historic value to society. To promote the formation of conservation easements, various state and federal governments have introduced tax benefits through either tax deductions or actual tax credits to reward and promote the formation of such conservation easements. Often, however, the landowner is unable to utilize fully the tax deductions generated by the formation and recording of the conservation easement on the landowner's property. To this end, the present invention provides a way of allowing the full benefit of the tax deduction and tax credits generated by the placement of a conservation easement on a particular property to be shared by those not originally part of the landownership that initially proposed and pursued the conservation easement. The invention proposes to bring together those landowners whose easements generate more tax deductions and benefits than otherwise possible to be utilized by the landowner and share them or transfer them to other groups who may be able to take full advantage of the maximum tax benefits and monetary interest provided in such tax incentives. Typically, the landowner receives some additional consideration as compensation for yielding the tax benefits to the other interested parties. It is through this maximizing the monetary interests that are provided through the tax incentives granted by the various states and federal governments that an increase in the formation and recordation of conservative easements is encouraged and promoted.

The formation of the conservation easements and the promotion thereof can be enhanced by first identifying a parcel of real property owned by a landowner that is suitable for the granting of a conservation easement. Typically, this landowner is unable to utilize the maximum monetary value generated by the conservation easement through the tax deductions and credits associated with the easement's reduction of value of the real property. An undivided interest in this parcel of land is sold to one or more individuals or a group of individuals such as a limited liability corporation, before the easement is recorded. The landowner receives some compensation directly for allowing the easement to be placed on the property. The individual or groups of individuals purchasing the interest then are then entitled to share in the monetary interest generated by the tax consequences of the easement being placed on the land. This group may either enjoy the monetary interest solely or share the interest with yet a third party in exchange for some type of consideration so that the remaining and maximum value of the monetary interest generated by the tax consequences may be fully utilized.

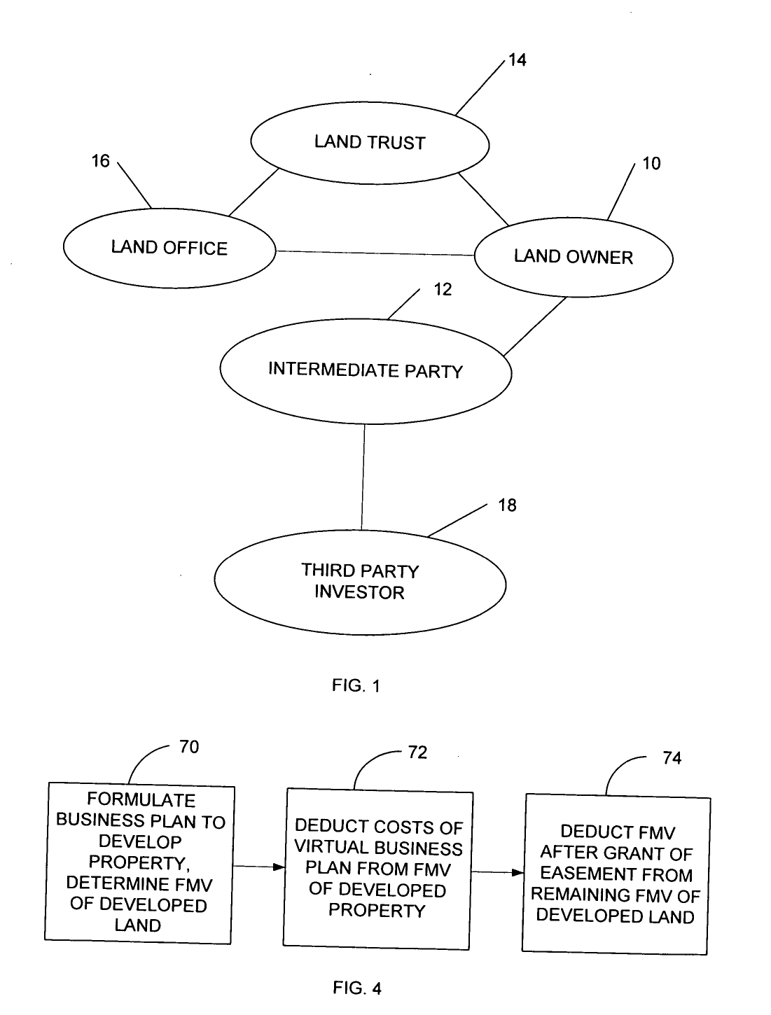

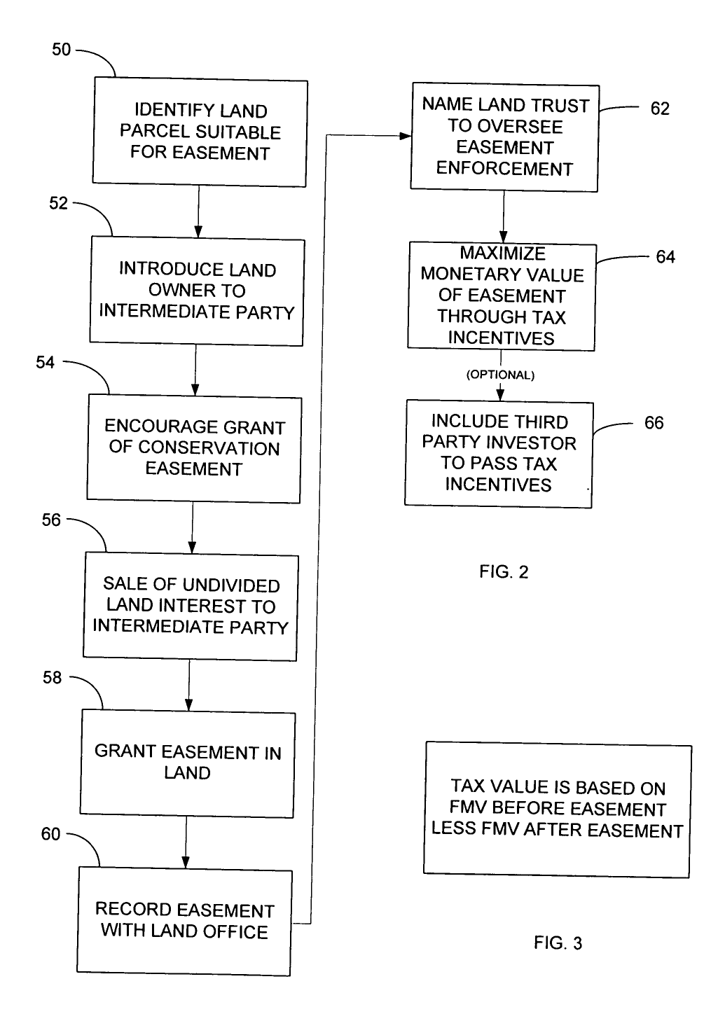

In order for the monetary interests and value in the real property to be transferred to these other parties, strict procedures must be followed so that the conservation easement qualifies as a tax deductible easement under Internal Revenue Code § 170(h). One requirement is that the conservation easement is managed by a non-profit organization that qualifies as a charitable contribution organization under Internal Revenue Code § 501(c)(3). FIG. 1 illustrates a relational diagram involving groups of individuals or entities that participate in the maximization of the utilization of monetary value realized in the formation of and placement of a conservation easement on a parcel of real property. FIG. 2 depicts the steps taken to enhance the grant of conservation easements as carried out by the groups of FIG. 1. A parcel of land is identified by the owner 10 upon which the conservation easement will be placed (block 50).

Typically, the property owner 10 whose land is to be encumbered with the easement is an individual or C Corporation that is unable to take full advantage of the tax benefits that accrue to the property and the owners through the placement of the easement on the property. An intermediate party 12 who has access to investor groups that have an interest in obtaining the monetary tax value that would otherwise be unrealized in real property is introduced to the property owner 10 (block 52). The intermediate party 12 may be an individual or a group of investors. This intermediate party 12 encourages the property owner 10 to participate in the conservation easement program (block 54). A real estate transaction occurs between these two entities 10 and 12 (block 56) and allows the intermediate party 12 to share and take advantage of the monetary value of the tax consequences of the easement. After the undivided interest has been sold to the intermediate party 12, the easement is recorded (block 58) in the land office 16 of the state of residence of the land. The easement is also granted to a qualified land trust 14 or state organization (block 60) to manage the easement so that it properly qualifies as a charitable deduction according to the specific state and federal regulations associated with the land.

If the intermediate party 12 has sufficient enough income that can be offset by the full value of the monetary interest of the tax consequences of the encumbering of the easement on the property, then the members or the individual in the intermediate party utilizes the full benefit of the tax consequences associated with the property (block 62). For example, if the landowner is merely an individual, often the value of the easement exceeds the adjusted gross income (AGI) deduction potential that the landowner could otherwise take individually. Although there are provisions for the deduction to be spread out over years, the value of the deduction is diluted by limiting the landowner to taking incremental deductions over the course of years. The value of the deduction is greatest when it is maximized in a given year, rather than spread out over multiple years. Consequently, the intermediate party 12 either has sufficient resources to be entitled to offsetting the value of the tax consequences against their own adjusted gross income or, the intermediate party 12 can act with a third party 18 (block 64), which typically is one or more investors that have sufficient enough AGI such that the full value of the tax consequences of the easement encumbrance on the real property can be fully realized by this third party 18.

With the exchange of consideration with the second party 12, the third party 18 receives the tax deductions in a pass-through mechanism allowed by the federal tax code. Typically, the consideration paid by the third party 18 is less than the full value of the tax deductions so that the third party 18 receives a benefit and has incentive to invest with the intermediate party 12. It is through the shifting of consideration from one party to another in exchange for the use of the monetary value of the tax consequences of the easement that encourages or promotes the placement of the easements on real property than would otherwise be possible if the landowner was the sole entity that could utilize the tax deductions associated with the easement.

The value of the tax deductions, as shown in the flow diagram of FIG. 3 is based on taking the difference of the value or fair market value (FMV) of the land before the easement and then assessing the value of the land after the easement. Often, however, the land is undeveloped at this point and so the market value of the land prior to the easement is rather low and the value of the property after the easement is not much less than the original value. In order to maximize the opportunity for promoting easements, the value of the land prior to the easement may be calculated by determining what the actual high market value of the land would be were it to be developed in a realistic business endeavor. This is shown in the flow diagram of FIG. 4. Typically, developed land is worth far more than undeveloped land and this is including deducting the cost incurred to develop the land for the business use. As such, what may be done is to formulate a business plan of developing the land (block 70), back out the actual costs required to develop that land (block 72), and then utilize the fair market value of the developed land in a virtual sense (block 74) in order to maximize the tax consequences that may be beneficial to the landowner and the investment group participating in the sharing of those tax benefits.

Thus if a parcel of property is worth $100,000 prior to development, and is worth only $60,000 after an easement is placed thereon, then the actual tax deduction would be $40,000, of which 35% to 40% typically passes through at the highest level of federal and state tax write off. A single property owner may not have sufficient incentive to forfeit land rights for this amount.

If, however, the property that is valued at $100,000 prior to development is developed in a virtual sense, in other words plans are formulated and costs are incurred and a fair market value assessment of what the land would be worth after the development has been performed, the value can be substantially increased. In this example, the developed land may be worth $500,000 after construction, with construction costs amounting only to $200,000. Thus, the value of the land would then be $500,000 less $200,000 which yields $300,000. This value is then deducted from the actual market value of the land with the easement in place, which is $60,000. Thus, the tax write off would then be $300,000 minus $60,000, yielding $240,000. This is much greater than the $40,000 that the landowner would have been entitled to under a straight fair market adjustment from pre-easement to post-easement.

In the case of the higher developed value, the landowner may not be able to maximize this write off against their own adjusted gross income, resulting in an economic loss. Further, if the landowner is a C Corporation, then the landowner is entitled to take merely a 10% deduction rather than the 30% deduction that is entitled to non C Corporation type entities. The value of a 10% deduction on $240,000 is merely $24,000. The value of a 30% deduction on $240,000 is $72,000, a $48,000 increase. The intermediate party 12 can then pass this $74,000 tax deduction to the third party 14 in exchange for consideration, typically the third party 14 may pay anywhere from 50% to 80% of the tax deduction value in order to receive even half or 20% of the actual tax deduction value. This still nets the third party anywhere from $10,000 to $30,000 in real money that would otherwise be lost where the landowner was the only entity entitled to utilizing the tax deduction.

It is to be understood that the above-referenced arrangements are only illustrative of the application for the principles of the present invention. Numerous modifications and alternative arrangements can be devised without departing from the spirit and scope of the present invention while the present invention has been shown in the drawings and fully described above with particularity and detail in connection with what is presently deemed to be the most practical and preferred embodiments(s) of the invention, it will be apparent to those of ordinary skill in the art that numerous modifications can be made without departing from the principles and concepts of the invention as set forth in the examples.

1. A method of encouraging the formation of conservation easements on real property comprising:
a) identifying a parcel of real property owned by a first party and suitable for securing a conservation easement wherein the first party is unable to utilize a maximum monetary value generated by the conservation easement;
b) selling an interest in the identified parcel of real property to an intermediate party qualified to receive maximum tax deduction benefit for the conservation easement;
c) processing the conservation easement on the parcel of real property with proper government authorities; and
d) exchanging at least a portion of the monetary value in the real property with the conservation easement to the intermediate party for consideration less than the maximum monetary value.

2. The method according to claim 1 further comprising the step of determining the monetary value of the real property with the conservation easement.

3. The method according to claim 2 wherein determining the monetary value comprises the step of generating a virtual development plan of the real property before granting of the conservation easement be granted.

4. The method according to claim 3 wherein the virtual development plan generating step comprises:
determining a market value of the real property before granting of the conservation easement;
determining a market value of the real property based on a business plan to develop the real property
determining the difference between the market value of the real property before granting the conservation easement and the market value of the real property as developed according to the business plan; and
substracting all costs needed to develop the real property according to the business plan.

5. The method according to claim 1 further comprising exchanging at least a portion of the monetary value in the real property in the real property with the conservation easement from the intermediate party to a third party for consideration less than the maximum monetary value.

6. A method of transferring a monetary value or interest from a first party landowner to a second party investor, comprising:
a) identifying a parcel of real estate owned by the first party landowner and suitable for securing a conservation easement wherein the first party landowner is unable to utilize a maximum monetary value generated by the conservation easement;
b) selling an interest in the identified parcel of real estate to an intermediate party qualified to receive maximum tax deduction benefit for the conservation easement;
c) processing the conservation easement on the parcel of real estate with proper government authorities; and
d) exchanging at least a portion of the monetary value in the conservation easement to the intermediate party for consideration less than the maximum monetary value.

7. A method of generating income through promotion of conservation easements, comprising the business steps of:
a) identifying a parcel of real estate owned by a landowner and suitable for securing a conservation easement wherein the landowner is unable to utilize a maximize tax interest generated by the conservation easement;
b) selling an undivided interest in the identified parcel of real estate to an intermediate party;
c) processing the conservation easement on the parcel of real estate with proper government authorities; and
d) exchanging a tax interest in the conservation easement to the intermediate party for consideration less than the value of the tax interest.
